(19) United States
(12) Patent Application Publication
(10) Pub. No.: US 2026/0074455 A1
(43) Pub. Date: Mar. 12, 2026

(54) LAND GRID ARRAY (LGA) SOCKET PINS AND HOUSINGS

(71) Applicants: Siva Prasad Jangili Ganga, Bengaluru (IN); Emad Shehadeh Al-Momani, Austin, TX (US); Eric Erike, Mesa, AZ (US); Steven A. Klein, Chandler, AZ (US); Yogesh Ramakrishna Kuthkanahalli, Bangalore (IN); Ismael Franco Núñez, Milwaukie, OR (US); Prakash Kurma Raju, Bangalore (IN); Jeeru Jawahar Reddy, Visakhapatnam (IN); Jeffory L. Smalley, Olympia, WA (US)

(72) Inventors: Siva Prasad Jangili Ganga, Bengaluru (IN); Emad Shehadeh Al-Momani, Austin, TX (US); Eric Erike, Mesa, AZ (US); Steven A. Klein, Chandler, AZ (US); Yogesh Ramakrishna Kuthkanahalli, Bangalore (IN); Ismael Franco Núñez, Milwaukie, OR (US); Prakash Kurma Raju, Bangalore (IN); Jeeru Jawahar Reddy, Visakhapatnam (IN); Jeffory L. Smalley, Olympia, WA (US)

(21) Appl. No.: 19/391,152

(22) Filed: Nov. 17, 2025

(51) Int. Cl. H01R 13/05; H01R 12/70; H01R 12/71; H01R 13/512

(52) U.S. Cl. CPC H01R 13/052; H01R 12/707; H01R 12/7076; H01R 12/7082; H01R 12/714; H01R 13/512

(57) ABSTRACT

Land grid array (LGA) sockets with low-profile housings and stamped cylindrical pins are disclosed. Each pin includes a top contact portion, a bottom contact portion, and a serpentine spring portion that compresses along the vertical axis. In some embodiments, a bent electrically conductive strip provides a shorter electrical path to support high-speed data transmission. In other embodiments, the pin comprises a stub that contacts a pin hole plating layer to provide a shorter electrical path. The pins may be formed from beryllium copper and plated with palladium-gold. The socket housing, formed from printed circuit board laminate layers, defines cavities that receive and constrain the pins to limit movement and prevent damage. Localized ground and power structures, including plated-through holes and shielding vias, reduce crosstalk. The low-profile socket designs enhance signal and power integrity while enabling cost-effective manufacturability through progressive stamping and laminate-based assembly.

Land Grid Array (LGA) sockets are electrical connectors used to mechanically and electrically couple an integrated circuit component to a printed circuit board. In an LGA interface, the integrated circuit component comprises a planar array of electrically conductive lands on its bottom surface, while the socket contains a corresponding array of electrically conductive pins that establish physical contact with the lands when the integrated circuit component is clamped in place in the socket. Some existing LGA sockets employ a cantilever beam approach, in which individual socket pins include an elongated spring arm that flexes upon integrated circuit component installation to generate a contact force against an integrated circuit component land.

### BRIEF DESCRIPTION OF THE DRAWINGS

FIG. 1 is a cross-sectional view of a microelectronics assembly comprising an LGA socket with pins having a cantilever beam design.

FIG. 2 is a cross-sectional view of a microelectronics assembly comprising an LGA socket with pins in accordance with any of the embodiments described herein.

FIGS. 3A and 3B illustrate a pre-formed top view and a fully formed side view, respectively, of a first example socket pin comprising a serpentine spring.

FIGS. 4A-4E illustrate various side views and a top view of the formed pin of FIG. 3B.

FIGS. 5A and 5B illustrate a pre-formed top view and a fully formed perspective view, respectively, of a second example socket pin comprising a serpentine spring.

FIGS. 6A and 6B illustrate exploded and assembled perspective views of a first example socket housing.

FIG. 7 illustrates a perspective view of an assembled second example socket housing.

FIG. 8 illustrates a perspective cross-sectional view of a portion of the assembled first example socket housing illustrated in FIGS. 6B, with the socket pins removed.

FIGS. 9A and 9B illustrate cross-sectional views of a portion of a first example assembly portion with a socket pin in uncompressed and compressed states, respectively, in a third example socket housing.

FIG. 10 illustrates a cross-sectional view of a portion of a second example assembly showing a compressed socket pin in a plated hole of a fourth example socket housing.

FIGS. 11A and 11B illustrate cross-sectional views of a portion of a second assembly showing a variation of the example socket pin of FIGS. 5A and 5B in compressed and uncompressed states, respectively, in a fifth example socket housing.

FIG. 12 illustrates a top view of a socket housing pin array comprising pins carrying differential pairs and shielded by power and ground pins.

FIG. 13 illustrates a top view of a socket housing pin array comprising pins carrying single-ended signals and shielded by power and ground pins.

FIG. 14 illustrates a cross-sectional view of FIG. 12 taken along the line A-A.

FIG. 15 is an example method of forming a socket pin.

FIG. 16 is a block diagram of a second example computing system in which technologies described herein may be implemented.

### DETAILED DESCRIPTION

Enterprise-class processor systems, such as high-end servers, increasingly require sockets capable of supporting extremely high-speed data transmission. In particular, next-generation LGA (land grid array) sockets must reliably accommodate signal frequencies exceeding 56 Gb/s while maintaining low or negligible crosstalk between adjacent pins. Additionally, enterprise customers demand socket designs that exhibit high mechanical reliability and durability while remaining cost-competitive with existing LGA socket solutions.

Some existing enterprise-class LGA sockets do not meet these high-frequency performance and reliability requirements. Some signal pins in current socket designs can have capacitive or inductive coupling between neighboring pins, leading to undesirable levels of crosstalk. Further, socket pin damage in existing LGA socket designs has been reported due to mishandling of the socket pins by end users, reducing overall reliability and serviceability.

Existing alternatives, such as sockets utilizing pogo-pins, offer reliability but fail to adequately suppress crosstalk at high signal frequencies. Moreover, pogo-pin sockets, which are typically employed in burn-in or test applications, possess a total height more than ten times that of some existing LGA sockets. Such pogo-pin-based designs are unsuitable for enterprise server implementations due to their excessive height, which can be incompatible with enterprise server form factors.

Disclosed herein are socket pins that can support the high-speed data rates desired by enterprise-class solutions; have low or zero crosstalk between adjacent pins, even at fine pitches; and provide mechanical robustness at a manufacturing cost comparable to existing socket designs. The socket pins disclosed herein are generally cylindrical in shape and comprise a top contact portion, a bottom contact portion, and a serpentine spring portion positioned between the top and bottom contact portions. The pins can comprise a bent strip that extends from the top contact portion to the bottom contact portion or a stub that physically contacts an inner surface of a partially plated pin opening to enable higher speed performance. The serpentine spring portion allows for compression along the height of the socket pin.

The socket housing comprises two thin printed circuit boards that, when attached, form pin openings within which socket pins are located. The use of a printed circuit board laminate enables localized customization of the pin field to include grounded and shielded regions surrounding selected signal pins, to reduce or eliminate signal crosstalk. The socket pins are formed via stamping and can be formed from beryllium copper (BeCu) to achieve high stiffness and fatigue strength. The pins can be plated with palladium-gold.

The disclosed socket structures provide at least the following advantages over some existing land grid array (LGA) socket housing and pins designs. The reduced overall stack height of the socket results in shorter electrical interconnect paths, improving signal integrity and power integrity (i.e., voltage droop, ground bounce, decoupling) characteristics. The stamped pin design allows for manufacturing cost levels comparable to conventional LGA sockets while achieving high reliability and signal speed capability exceeding 56 Gb/s. Crosstalk between adjacent pins is reduced or minimized through the inclusion of localized shielding within the printed circuit board-based housing. The cylindrical pin geometry and constrained enclosure yield mechanical reliability comparable to pogo-pin style contacts while maintaining a lower profile. Furthermore, the printed circuit board-based socket housing can be tailored to meet specific signal integrity, power integrity, and grounding requirements of enterprise- and client-class electronic systems, thereby providing high-performance and cost-effective interconnect solutions.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or in any other manner.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

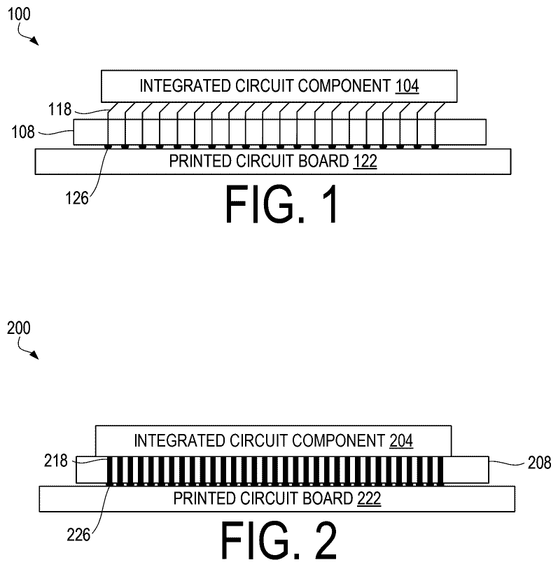

FIG. 1 is a cross-sectional view of a microelectronics assembly comprising an LGA socket with pins having a cantilever beam design. The assembly 100 comprises an integrated circuit component 104 attached to an LGA socket 108 via pins 118 having a cantilever beam design. The LGA socket 108 is attached to a printed circuit board 122 via solder connections 126.

FIG. 2 is a cross-sectional view of a microelectronics assembly comprising an LGA socket with pins in accordance with any of the embodiments described herein. The assembly 200 comprises an integrated circuit component 204 attached to an LGA socket 208 that comprises pins 218. The pins have a cylindrical shape and comprise a serpentine spring structure. The LGA socket 208 is attached to the printed circuit board 222 via solder connections 226. As indicated by the cross-sectional views illustrated in FIGS. 1 and 2, the pins 218 have a higher density and enable a lower stack height (e.g., the distance from the top surface of the printed circuit board to the bottom surface of the integrated circuit component) than pins 118.

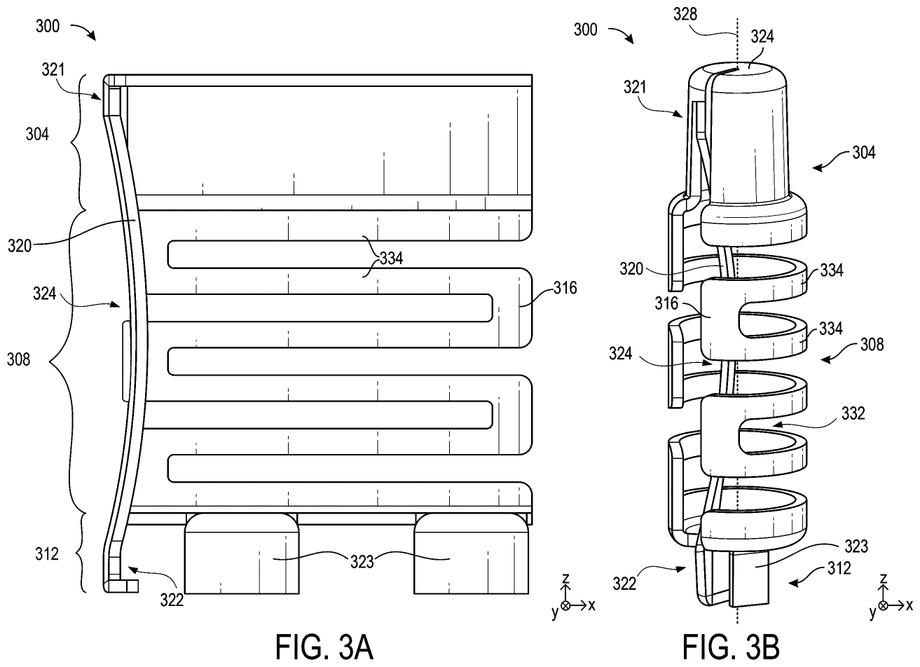

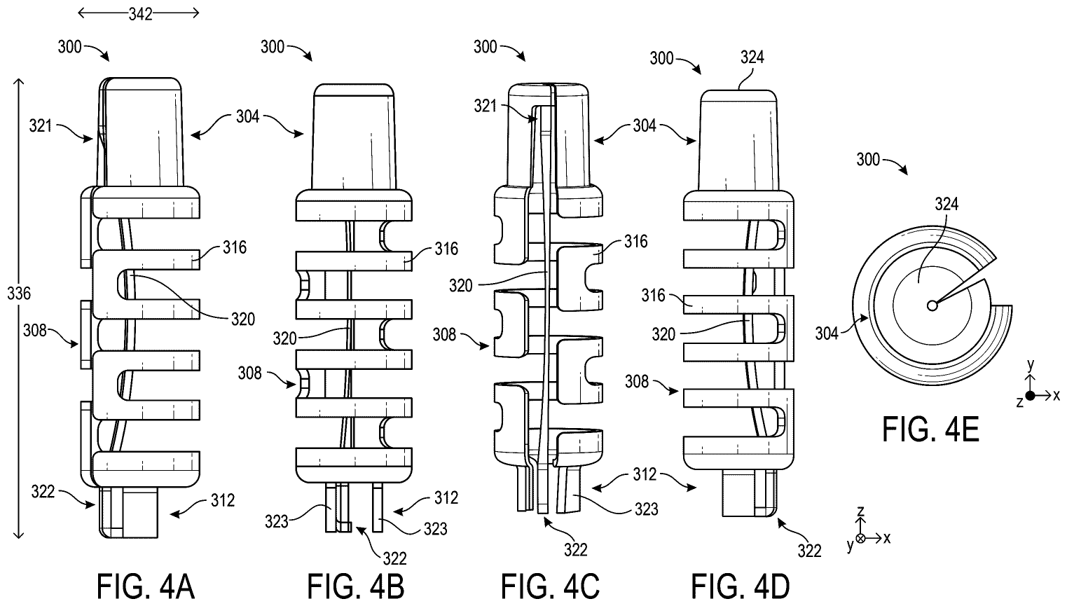

FIGS. 3A and 3B illustrate a pre-formed top view and a fully formed side view, respectively, of a first example socket pin comprising a serpentine spring. FIGS. 4A-4E illustrate various side views and a top view of the formed pin of FIG. 3B. The socket pin (pin 300) comprises a top contact portion 304, a bottom contact portion 312, and a serpentine spring portion 308 positioned between and attached to the top contact portion 304 and the bottom contact portion 312. When used in a socket, the top contact portion 304 is to be in physical contact with an electrically conductive land (pad) on an integrated circuit component, and the bottom contact portion is attached to a printed circuit board via a solder (e.g., solder ball, solder paste), press-fit, or other suitable connection. The top contact portion 304 is kept in contact with an integrated circuit component land through application of a mechanical load, which can be applied by, for example, a lever- or fastener-based load mechanism.

The serpentine spring portion 308 comprises a plurality of curved segments 316 arranged alternately in opposite directions to define a generally S-shaped path between the top and bottom contact portions. The pin 300 further comprises a strip 320 that extends along the height of the pin 300. A top end 321 of the strip 320 attaches to a top portion of the top contact portion 304 and a bottom end 322 of the strip 320 is part of the bottom contact portion 312. In other embodiments, the top end 321 of the strip 320 can attach to any portion of the top contact portion 304 or a top portion of the serpentine spring portion 308. In some embodiments, the bottom end 322 of the strip 320 can attach to any portion of the bottom contact portion 312 or a bottom portion of the serpentine spring portion 308. Further, although the bottom end 322 of the strip 320 is illustrated in FIGS. 3A-3B and 4A-4D as being separate from other portions of the bottom contact portion 312 (i.e., portions 323), in some embodiments, the bottom end 322 of the strip 320 can be attached to another portion of the bottom contact portion 312 or be an integral part of the bottom contact portion 312. Similarly, although the top end 321 of the strip 320 as illustrated in FIGS. 3A-3B and 4A-4D is shown as attaching to a top portion of the top contact portion 304, in other embodiments, a top end 321 of the strip 320 can be separate from other portions of the top contact portion 304 or be an integral part of the top contact portion 304.

The strip 320 comprises a bend 324 that extends towards a vertical centerline 328 of the pin 300 when the pin is fully formed. Put another way, the bend 324 extends towards an interior 332 of the serpentine spring portion 308 in the fully formed version of the pin 300.

The serpentine spring portion 308 allows the pin 300 to be compressed along its z-axis when an integrated circuit component is secured in a socket via application of a mechanical load. Thus, the serpentine spring portion 308 serves the purpose of carrying an electrical signal and, when compressed, providing a spring force to the top contact portion 304 to keep the top contact portion 304 in physical contact with an integrated circuit component land. In some embodiments, the pin 300 can have a stroke range of about 0.25 millimeters to about 0.3 millimeters. In some embodiments, the pin 300 can have a stroke range of less than 0.3 millimeters.

The serpentine spring portion 308 can be implemented in a variety of geometries to achieve desired characteristics. For example, spring segments 334 between S-bends need not be parallel to one another. Further, the length of the spring segments between the S-bends and/or the curvature of the S-bends may vary along the spring length to provide localized regions of higher or lower flexibility. In some embodiments, the width or thickness of the spring segments may vary along the spring length to adjust the stress distribution or contact force profile. These variations may be defined within the stamped geometry and formed during the progressive stamping process.

The pin 300 can comprise beryllium copper (BeCu, a metal alloy comprising beryllium and copper). Beryllium copper is suitable for use in socket pins due to its high strength, elasticity, and electrical conductivity. In other embodiments, the pin 300 can comprise another suitable conductive material. The pin 300 can comprise a coating, such as palladium-gold (PdAu, a material comprising palladium and gold), nickel, copper and zinc, or another suitable material.

The height 336 of the pin in its uncompressed state can be in a range of about 1.8 millimeters to about 2.3 millimeters, about 1.8 millimeters, or less than about 2.0 millimeters. In some embodiments, a diameter 342 of the pin at the serpentine spring portion 308 can be in the range of about 0.6 millimeters to about 0.8 millimeters, about 0.6 millimeters, or less than about 0.6 millimeters. The serpentine spring portion 308 comprises five curved segments 316, but can have any number of turns in other embodiments.

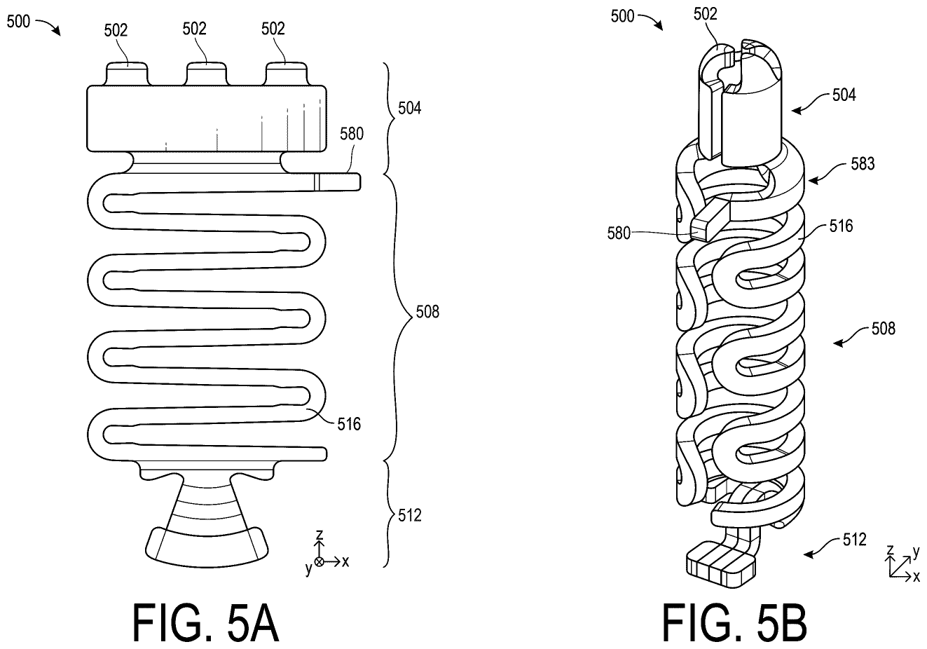

As can be seen, for an electrical signal to pass from the top contact portion 304 to the bottom contact portion 312, it must travel the full length of the serpentine spring portion 308. For a pin having the configuration of pin 300 and a height of about 1.6 millimeters, the length of the serpentine spring portion can be about 4.0 millimeters. Strip 320 provides a separate, and shorter, electrically conductive path for a signal to travel between the top and bottom contact portions, improving signal speed and reducing signal loss. The bend 324 in the strip 320 aids in controlling which direction (toward the interior 332 of the serpentine spring portion 308) the strip 320 is to deform when the pin 300 is compressed. In embodiments where the delay of an electrical signal passing through the serpentine spring portion still provides a desired level of signal performance, a socket pin comprising a serpentine spring portion may not include a strip, such as strip 320. Pin 500 illustrated in FIGS. 5A-5B is an example of one such pin. The absence of such a strip can simplify and reduce the cost of the socket pin manufacturing process.

The pin 300 may be formed by first forming a planar workpiece from a flat strip of metal or metal alloy. The planar workpiece is then subjected to one or more stamping operations, such as shearing, punching, bending, notching, and rolling, to define a three-dimensional cylindrical socket pin. In some embodiments, the stamping operations may be performed as part of a progressive stamping process in which successive die stages incrementally form the pin shape. The geometry of the serpentine spring portion 308 is suited for formation by a stamping process. Formation of socket pins via a stamping process can enable high-volume production of low-cost socket pins at a cost that may be comparable to some existing land grid array (LGA) socket pins.

FIGS. 5A and 5B illustrate a pre-formed top view and a fully formed perspective view, respectively, of a second example socket pin comprising a serpentine spring. The socket pin (pin 500) has a generally similar overall structure to pin 300. The pin 500 comprises a top contact portion 504, a bottom contact portion 512, and a serpentine spring portion 508 positioned between and attached to the top contact portion 504 and the bottom contact portion 512. The top contact portion 504 is to contact with an electrically conductive land on an integrated circuit component, and the bottom contact portion 512 is to be attached to a printed circuit board. The serpentine spring portion 508 is illustrated as having seven bends, but can have more or fewer in other embodiments. The top contact portion 504 comprises a plurality of tabs 502 that contact an electrically conductive land of an integrated circuit component when the pin is compressed in a loaded socket. The serpentine spring portion 508 comprises a stub 580 that extends outward from the serpentine spring portion 508. The stub 580 is located at a top portion of the serpentine spring portion 508 (e.g., where the serpentine spring portion 508 meets the top contact portion 504). The stub 580 extends outward from an outer surface 583 of a coil of the serpentine spring portion 508 to which the stub 580 is attached. Put another way, the stub 580 extends outward from the surface of a cylinder defined by the extent to which the serpentine spring portion 508 extends from a vertical centerline of the pin 500 (not including the stub 580). In some embodiments, the stub 580 extends outward from the top contact portion 504. The stub 580 can have an elongated shape, as shown, or any other suitable shape. The stub 580 comprises an electrically conductive material, which can be the same as or different from the material used for the serpentine spring portion 508.

The serpentine spring portion 508 comprises a plurality of curved segments 516 arranged alternately in opposite directions to define a generally S-shaped path between the top and bottom contact portions. It is to be noted that the pin 500 does not have a bent strip connecting the top and bottom portions to provide a shorter signal path. Thus, the pin 500 may be used in applications where signaling speed demands are not as great as they are for applications in which the pin 500 may be used. The absence of a strip connecting the top contact portion 504 to the bottom contact portion 512 may result in pin 500 being simpler and/or less expensive to manufacture than pin 300.

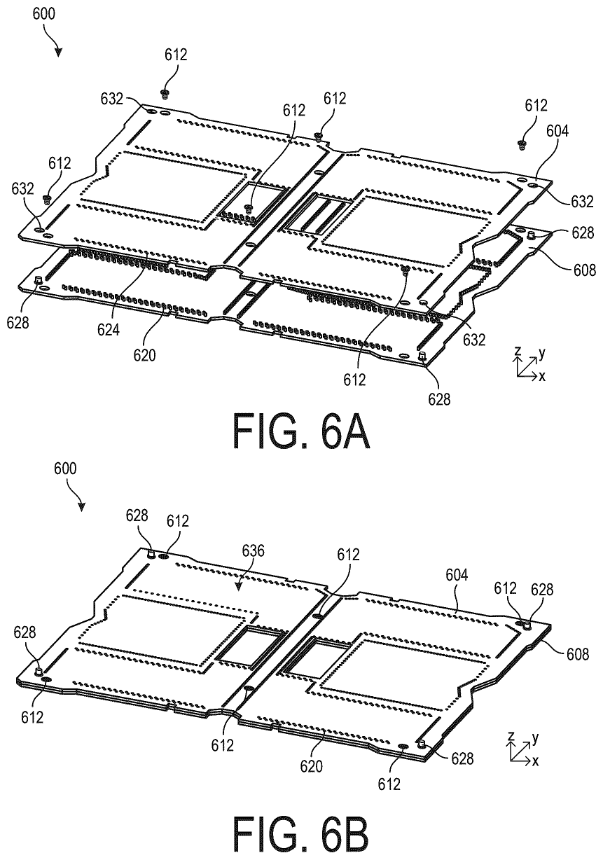

FIGS. 6A and 6B illustrate exploded and assembled perspective views of a first example socket housing. The socket housing (housing 600) comprises a top board 604 attached to a bottom board 608 by fasteners 612 (e.g., screws). The bottom board 608 comprises socket pins (pins 620, e.g., pin 300, 500) inserted into openings in the bottom board 608, and the top board 604 comprises holes 624 through which the pins 620 extend when the top and bottom boards are attached. The bottom board 608 further comprises alignment pins 628 that extend through alignment pin openings 632 in the top board 604. A portion of each of the pins 620 extends past a top surface 636 of the top board 604 when the boards are assembled and before an integrated circuit component is attached to the housing 600. It is to be noted that the housing 600 illustrates only a subset of the pins that would be accommodated in a typical housing. In typical socket designs, one or more of the regions of the top board 604 and bottom board 608 illustrated as being devoid of pins or holes would be predominantly filled with pins. In modern socket designs, a socket housing for client-class integrated circuit components can have in the range of 1,000 to 2,000 socket pins and over 9,000 socket pins for some next-generation enterprise-class servers.

In some embodiments, the top board 604 and bottom board 608 comprise printed circuit board (PCB) laminate. In some embodiments, the PCB laminate is a composite material formed by impregnating a woven glass fabric with a thermosetting resin and curing the material under heat and pressure to form a rigid, electrically insulating layer. The PCB laminate can comprise, for example, FR-4 epoxy glass, polyimide glass, or polytetrafluoroethylene (PTFE)-based composites. The use of printed circuit board (PCB) laminate in place of a traditional injection-molded socket body provides electrical advantages. The PCB laminate may incorporate plated-through holes and customized ground or power routing for the reduction or elimination of crosstalk between signals, as will be discussed in greater detail below.

In some embodiments, the top board 604 and bottom board 608 each have a thickness in the range of about 0.9 millimeters to about 1.0 millimeters. In some embodiments, the top and bottom boards each have a thickness of less than about 1.0 millimeters. In some embodiments, the top and bottom boards each have a thickness of about 0.95 millimeters or less, and the assembled socket housing has a thickness of 1.85 millimeters or less. This is less than the height of some existing LGA sockets, which can exceed five millimeters. In some embodiments, the housing 600 can be assembled by placing socket pins in holes in the bottom board 608 and the top board 604, then being attached to the bottom board 608.

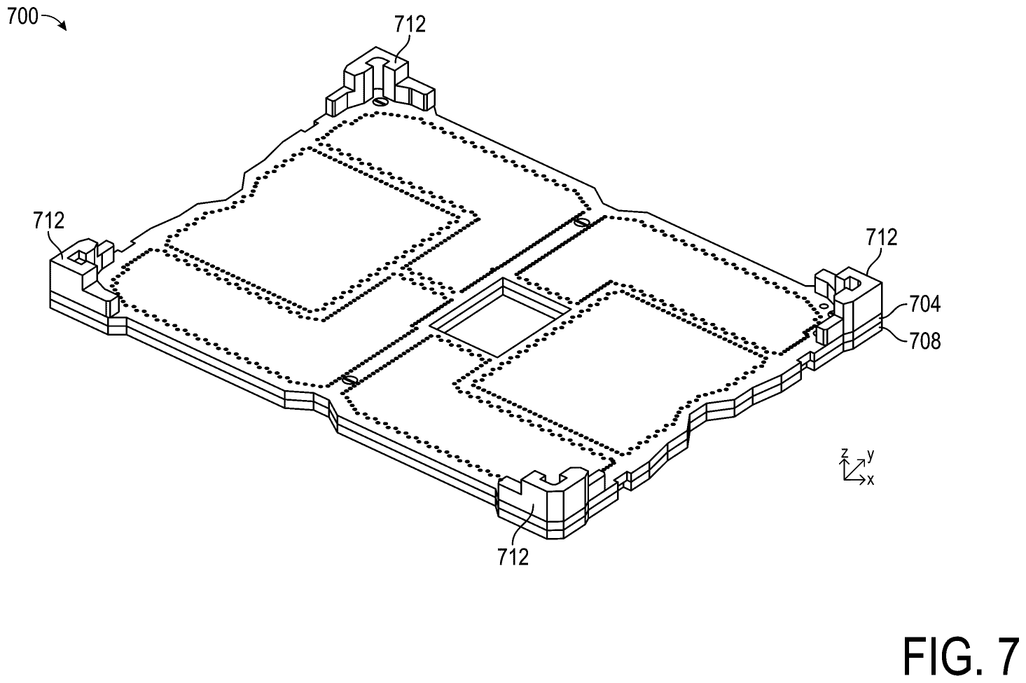

FIG. 7 illustrates a perspective view of an assembled second example socket housing. The socket housing 700 comprises a top board 704 attached to a bottom board 708. The top board and the bottom board can comprise any of the features and characteristics described above in regard to the top and bottom boards illustrated in FIGS. 6A and 6B. The socket housing 700 comprises alignment frames (frames 712) to align the top board 704 to the bottom board 708. The frames 712 comprise holes on their underside (holes not shown) that align with pins attached to the bottom board 708 that extend through the top board 704 (pins not shown). The frames 712 further allow for alignment of an integrated circuit component with the socket housing 700.

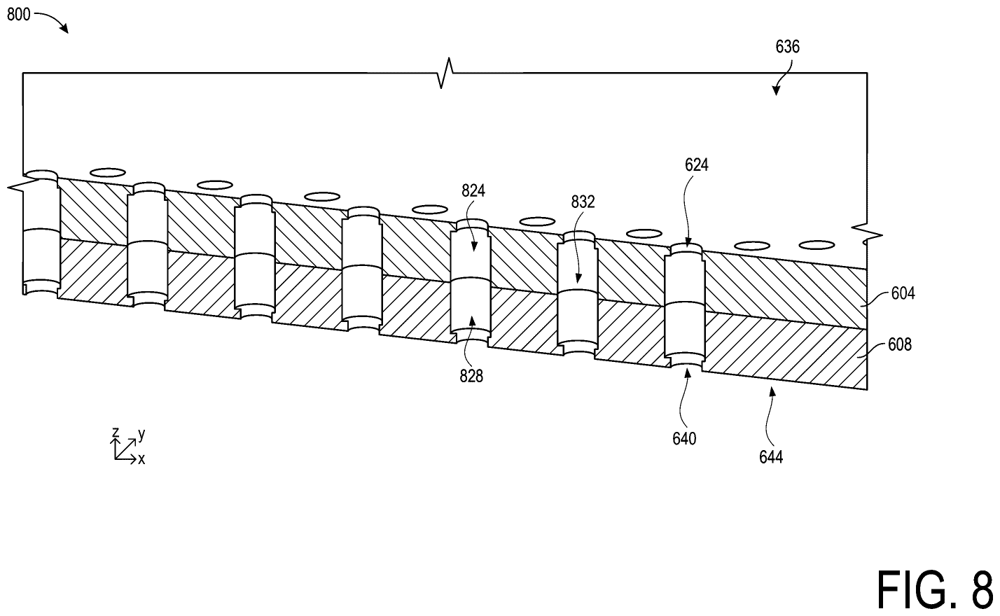

FIG. 8 illustrates a perspective cross-sectional view of a portion of the assembled socket housing illustrated in FIGS. 6B, with the socket pins removed. The socket housing portion 800 comprises the top board 604 attached to the bottom board 608, holes 624 in a top surface 636 of the top board 604, and holes 640 in a bottom surface 644 of the bottom board 608. Each of the holes 624 is part of a top board opening 824 that extends through the top board 604, and each of the holes 640 is part of a bottom board opening 828 that extends through the bottom board 608. A top board opening 824 aligned with a bottom board opening 828 defines a pin opening 832, which can accommodate a socket pin (e.g., pin 300, 500). As will be discussed in greater detail below, retention features in the top board and bottom board openings prevent socket pins from dislodging from pin openings.

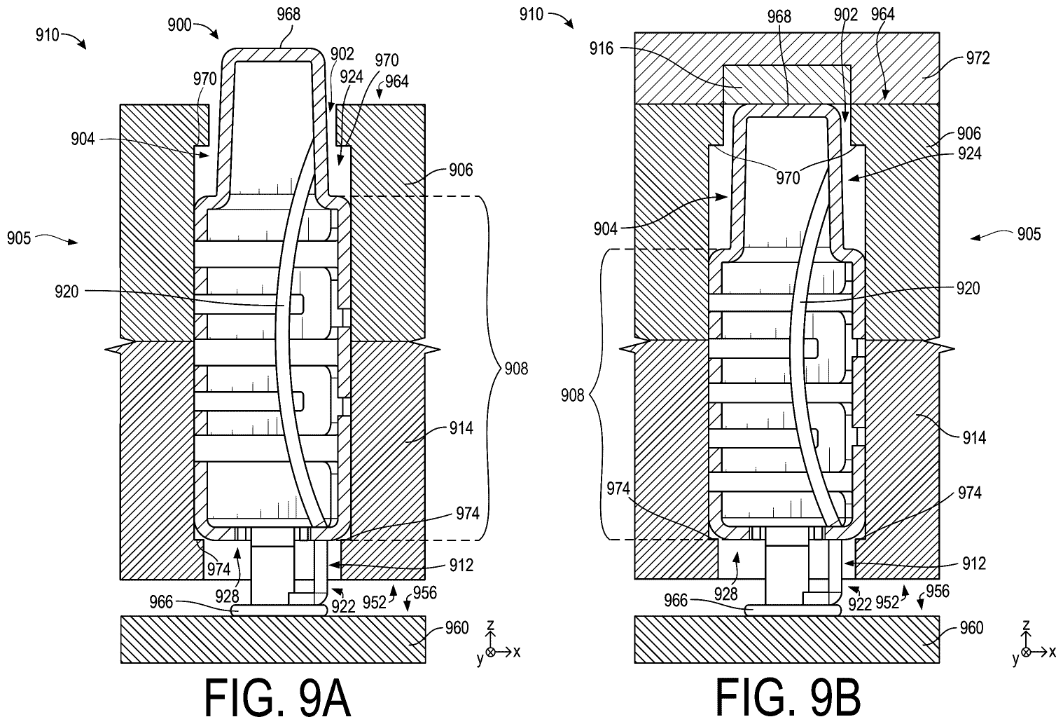

FIGS. 9A and 9B illustrate cross-sectional views of a portion of a first example assembly portion with a socket pin in uncompressed and compressed states, respectively, in a third example socket housing. The assembly portion 910 comprises a socket pin (pin 900) located in a pin opening 902 extending through a top board 906 and a bottom board 914 of a socket housing 905. The pin 900 is attached to a printed circuit board 960. The socket housing 905 can have the configuration of any socket housing described or referenced herein (e.g., housing 600). The pin 900 has the configuration of pin 300 (having similarly numbered features, i.e., top contact portion 904, serpentine spring portion 908, bottom contact portion 912, strip 920, bottom end of strip 922) but could have the characteristics of any other pin described herein.

A portion of the bottom contact portion 912 extends past a bottom surface 952 of the bottom board 914 and is attached to a surface 956 of a printed circuit board 960 via a solder connection 966 (e.g., solder ball, solder paste). The pin opening 902 comprises a top board hole 924 aligned with a bottom board hole 928. In some embodiments, the bottom contact portion 912 does not extend past the bottom surface 952 of the bottom board, but the pin 900 is still attached to the printed circuit board 960 via a solder connection 966.

The pin 900 is held within the pin opening 902 by ledges 970 and 974 in the top board hole 924 and bottom board hole 928, respectively. The ledges 970 and 974 are shown as substantially parallel to a top surface 964 of the top contact portion 904, but could be at an oblique angle to the top surface 964 or have any other shape that narrows the pin opening 902 near the top surface 964 of the top board 906 and bottom surface 952 of the bottom board 914, respectively, in other embodiments. In other embodiments, other suitable features can retain the socket pins described herein within an assembled socket housing. For example, with reference to pin 500, the stub 580 can aid in retaining the pin 500 within a socket housing.

In the uncompressed pin state illustrated in FIG. 9A, a portion of the top contact portion 904 of the pin 900 extends past a top surface 964 of the top board 906. To place the pin 900 in the compressed state illustrated in FIG. 9B, an integrated circuit component 972 is attached to the socket and a mechanical load applied to the integrated circuit component 972 exerts a downward force on the pin 900, causing it to compress. As can be seen in FIGS. 9A and 9B, in the compressed state, the serpentine spring portion 908 has a shorter height than it does in its uncompressed state. Finite element analysis of the pin design illustrated in FIGS. 5A-5B indicate a compression of 0.21 millimeters under a load of 15 N and 0.40 millimeters under a load of 30 N. The downward force exerted by the integrated circuit component 972 against the pin 900 causes a top surface 968 of the top contact portion 904 to become substantially flush with the top surface 964 of the top board 906 and the top surface 968 to be placed in physical contact with a land 916 of the integrated circuit component 972. The land 916 comprises a suitable electrically conductive material, such as copper, nickel, gold, tin, or a combination thereof. In the compressed state illustrated in FIG. 9B, the pin maintains contact with the land 916 by the biasing force of the serpentine spring portion.

By having the mechanical load imparted to a socket pin by an integrated circuit component being borne along the z-axis of the pin by the serpentine spring portion (rather than by a cantilever beam configuration), the socket housing and pin designs disclosed herein can provide for a more reliable socket design. In some embodiments, socket pins are enclosed within a tight jacketed region having an approximate clearance of 0.2 millimeters, which limits lateral movement and reduces susceptibility to handling damage or mechanical deformation.

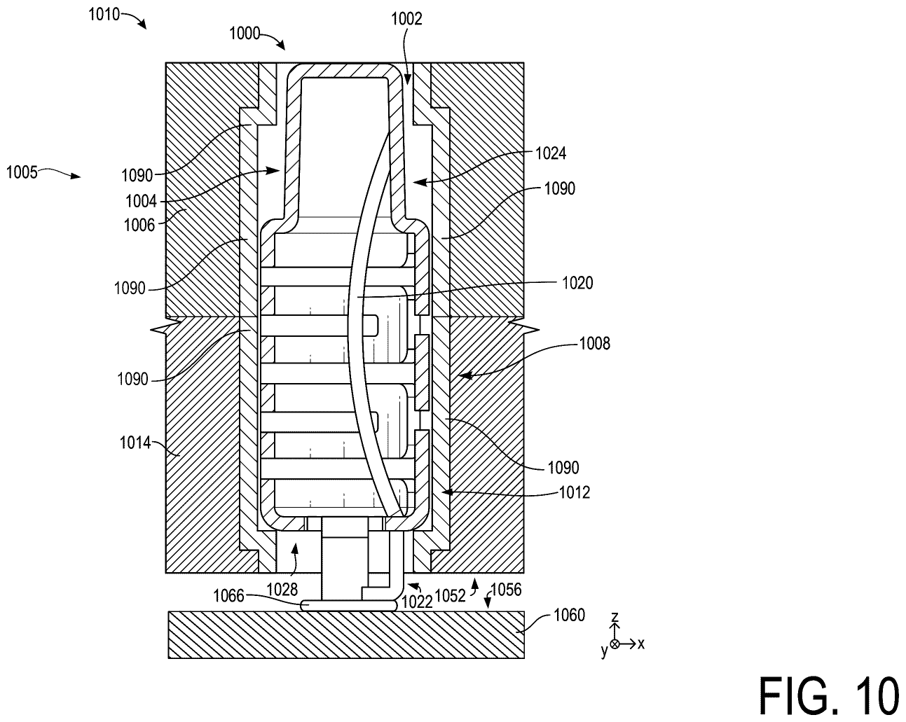

FIG. 10 illustrates a cross-sectional view of a portion of a second example assembly portion with a compressed socket pin in a plated hole of a fourth example socket housing. The assembly portion 1010 comprises a socket pin (pin 1000) located in a pin opening 1002 extending through a top board 1006 and a bottom board 1014 of a socket housing 1005. The pin 1000 is attached to a printed circuit board 1160. The socket housing 1005 can have the configuration of any socket housing described or referenced herein (e.g., housing 600). The pin 1000 has the configuration of pin 300 (having similarly numbered features (i.e., top contact portion 1004, serpentine spring portion 1008, bottom contact portion 1012, strip 1020, bottom end of strip 1022) but could have the characteristics of any other pin described herein. A bottom contact portion 1012 of the pin 1000 extends past a bottom surface 1052 of the bottom board 1014 and is attached to a surface 1056 of a printed circuit board 1060 via a solder connection 1066. The pin opening 1002 comprises a top board opening 1024 aligned with a bottom board opening 1028.

The assembly portion 1010 is similar to the assembly portion 910, but with the addition of a metal layer 1090 located on the interior surfaces of the pin opening 1002 (i.e., on the interior surfaces of the top board opening 1024 and the bottom board opening 1028). The metal layer 1090 is positioned between the interior surfaces of the top and bottom boards and the pin 1000. Reference to a “plated” opening (or plated hole, plated through-hole) herein refers generally to an opening having a metal layer formed on its interior surface, whether the metal layer is produced by plating, deposition, conductive filling, insertion of a metal sleeve, or any other metallization technique. The metal layer 1090 can comprise copper or another suitable metal, metal alloy, or other electrically conductive material. Plated openings in a socket housing can be used to reduce or eliminate crosstalk between signals passing through the socket housing. In some embodiments, some or all of the pins in a socket not carrying power or ground signals can be located in plated openings. In some embodiments, pins in a socket housing carrying power supply or ground signals can pass through openings that are not plated, such as the pin openings illustrated in FIGS. 9A and 9B. In some embodiments, plated pin openings can have a diameter that is greater than pin openings that are not plated, in order to accommodate the thickness of the metal layer.

In some embodiments, the cost of manufacturing any of the socket housings disclosed herein may be somewhat higher than that of a traditional socket. However, on an iso-cost basis, the LGA sockets described herein may provide approximately twice the performance of a conventional LGA socket.

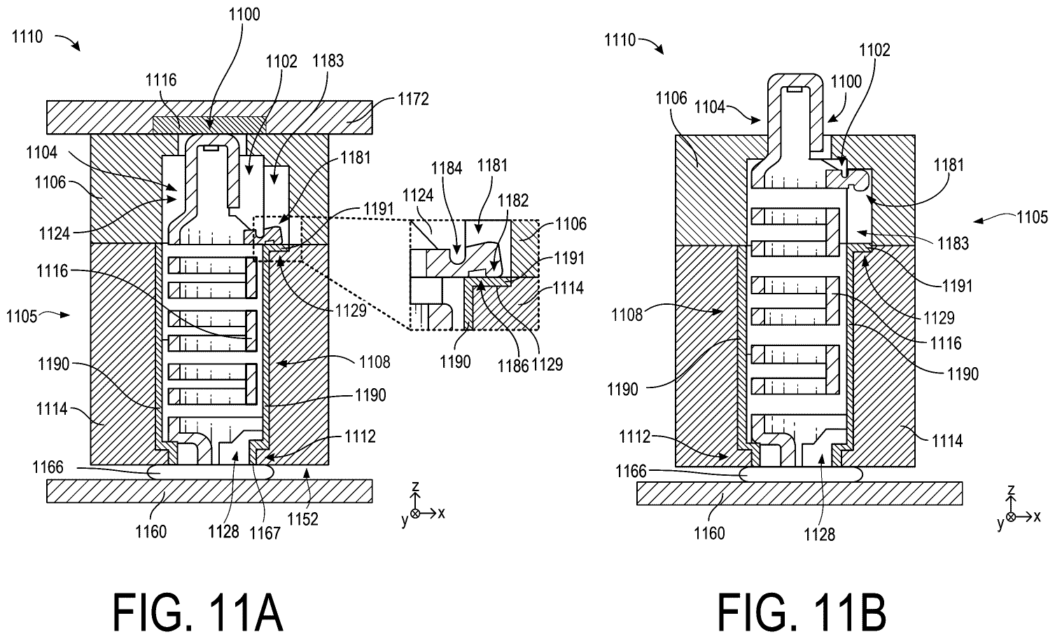

FIGS. 11A and 11B illustrate cross-sectional views of a portion of a third assembly portion showing a variation of the second example socket pin of FIGS. 5A and 5B in compressed and uncompressed states, respectively, in a fifth example socket housing. The assembly portion 1110 comprises a socket pin (pin 1100) located in a pin opening 1102 extending through a top board opening 1124 in a top board 1106 and a bottom board opening 1128 in a bottom board 1114 of a socket housing 1105. The socket housing 1105 can have the configuration of any socket housing described or referenced herein (e.g., housing 600). The pin 1100 is a variation of pin 500 illustrated in FIGS. 5A and 5B (having similarly numbered features (i.e., top contact portion 1104, serpentine spring portion 1108, bottom contact portion 1112), with stub 1181 of pin 1100 having a different shape than stub 580 of pin 500, and the pin opening 1102 comprising a stub recess 1183. The pin 1100 is compressed via an integrated circuit component 1172 applying a mechanical load to the pin 1100. The mechanical load keeps a land 1116 in physical contact with the top contact portion 1104 of the pin 1100.

The pin opening 1102 is a partially plated through hole. The pin opening 1102 is partially plated in that a metal layer 1190 is located on the interior surfaces of the bottom board opening 1128 and not on interior surfaces of the top board opening 1124. The metal layer 1190 can be referred to herein as a pin hole plating metal layer. The metal layer 1190 comprises a contact region 1191 that is located on a bottom surface 1129 of the stub recess 1183. The metal layer 1190 can have the features and be produced by any of the methods described above in regard to metal layer 1090. As can be seen, when the pin 1100 is in a compressed state defined by an integrated circuit component being attached to the socket housing, the stub 1181 is in physical contact with the contact region 1191. The stub 1181 and the metal layer 1190 thus provide an electrically conductive path for signals to travel between the top contact portion 1104 and the bottom contact portion 1112 that is shorter than the length signals would have to travel through the serpentine spring portion 1108. As such, the stub 1181 and the metal layer 1190 play a similar role in pin 1100 as the strip 320 plays in pin 300 to enable high-speed signaling performance.

The metal layer 1090 is electrically conductively coupled to the printed circuit board 1160 by the solder connection 1166. That is, a portion of the solder connection 1166 is positioned between a surface 1167 of the metal layer 1190 at a bottom surface 1152 of the socket housing 1105 (bottom board 1114). In other embodiments, the solder connection 1166 does not extend for enough laterally to provide an electrically conductive path directly between the metal layer 1190 and the printed circuit board 1160, and signals that travel from the integrated circuit component 1172 to the printed circuit board 1160 through the stub 1181 and the metal layer 1190 pass through the bottom contact portion 1112 and the solder connection 1166 to reach the printed circuit board 1160.

FIG. 11A contains a detailed view of the stub 1181. The stub 1181 comprises a bump 1182 that extends past the bottom surface of the remainder of the stub 1181 and contacts the contact region 1191 when the pin 1100 is in its compressed state. The stub 1181 bends when the pin 1100 is in its compressed state and thus provides a spring load that aids in keeping the bump 1182 in direct physical contact with the contact region 1191 when the pin 1100 is compressed. Cavities 1184 and 1186 aid in allowing the stub 1181 to bend. The stub 1181 can comprise any material that is both electrically conductive and that allows the stub 1181 to bend when the pin 1100 is compressed. In other embodiments, the stub 1181 can have any other suitable shape that allows for the stub 1181 to bend when the stub 1181 comes in contact with the contact region 1191 when the pin 1100 is compressed (e.g., more or fewer cavities, features other than cavities). In some embodiments, the stub 1181 is rigid and does not bend when the pin 1100 is in its compressed state.

With reference to FIG. 11B, when the pin 1100 is in an uncompressed state (e.g., when no integrated circuit component is attached to the socket housing), the stub 1181 is not in physical contact with the metal layer 1190. The stub recess 1183 is sized to accommodate the stub 1181 when the pin 1100 is in its compressed or uncompressed state, and for travel of the stub 1181 between its locations when the pin 1100 is in its compressed and uncompressed states.

Finite element analysis socket pin designs described herein comprising a serpentine spring portion indicate that under a compressive load of about 15 gram-force (gf), which may be needed to establish electrical contact between a pin and an integrated circuit component land, the pin's height is compressed by about 0.2 millimeters. Finite element analysis results further indicate that plastic deformation may not occur until a pin is compressed by 0.4 millimeters. The socket pin designs disclosed herein can thus be accommodated by existing socket designs where the clamping load to secure an integrated circuit component to a socket is on the order of hundreds of Newtons. In embodiments where a load less than 15 gf is needed to establish electrical contact, the number of pins that can be accommodated in a socket design can extend into the thousands.

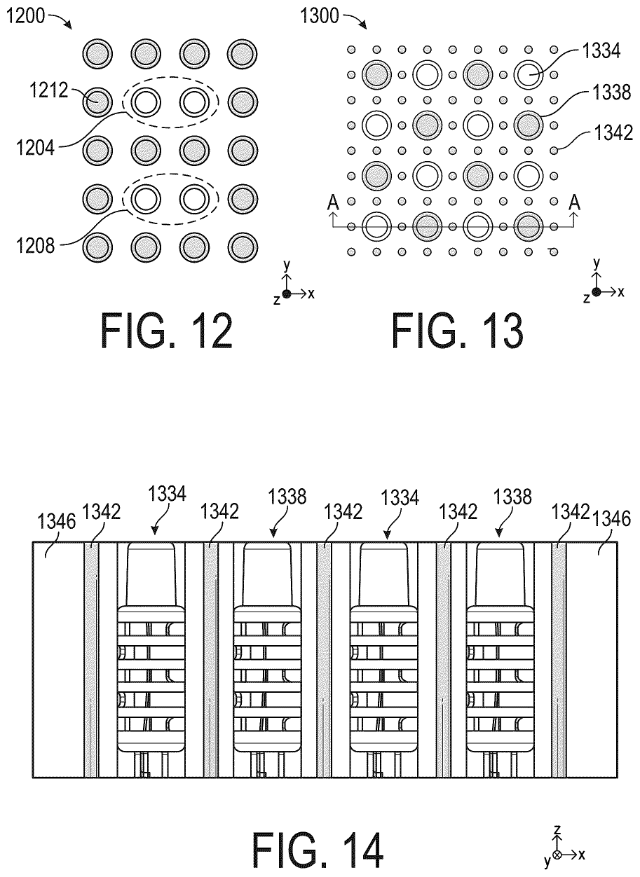

FIG. 12 illustrates a top view of a socket housing pin array comprising pins carrying differential pairs and shielded by power and ground pins. The pin field 1200 comprises pin pairs 1204 and 1208 carrying differential signal pairs, such as those used in high-speed input/output (HSIO) interfaces (i.e., Peripheral Component Interconnect Express (PCIe), Ultra Path Interconnect (UPI), and Transmission Control Protocol (TCP)). In order to reduce or eliminate crosstalk between the pin pairs 1204 and 1208, as well as between either of the pin pairs 1204 or 1208 and other differential signal pin pairs, the pin pairs 1204 and 1208 are shielded by pins 1212 (grey-shaded pins) carrying power or ground. In the pin arrangement shown in FIG. 12, the pins 1212 providing shielding for pin pair 1204 or 1208 are the pins that are the nearest neighbors to the pin pair 1204 or 1208. Shielding pin configurations other than the eight-pin shielding pin configuration illustrated in FIG. 12 are possible. For example, a differential signal pin pair can be shielded by six power and/or ground pins-two pins above, two pins below, and one pin on each side of the differential signal pin pair.

FIG. 13 illustrates a top view of a socket housing pin array comprising pins carrying single-ended signals and shielded by power and ground pins. FIG. 14 illustrates a cross-sectional view of FIG. 13 taken along the line A-A. The pin field 1300 comprises single-ended signal pins (signal pins 1334, the non-shaded pins in FIG. 13) shielded by vias 1342 and pins 1338 (grey-shaded pins) carrying power or ground signals to reduce or eliminate crosstalk between the signal pins 1334. In the pin arrangement shown in FIG. 13, the pins 1338 providing shielding for a signal pin 1334 are the pins that are the nearest neighbors to the signal pin 1338. The signal pins 1334 and 1338, and vias 1342, extend through a socket housing 1346.

Vias 1342 can be left floating or tied to a power signal or ground. FIG. 13 illustrates signal pins 1334 shielded by both vias 1342 and power or ground pins 1338, but in some embodiments, a signal pin 1334 can be shielded by either vias or power or ground pins. In embodiments where a signal pin 1334 is shielded by vias 1342, the vias and the signal pin can be configured in a grid-like arrangement defining three rows and three columns, with the signal pin being located at an intersection of a middle row of the three rows and a middle column of the three columns and surrounded by eight vias. Other via configurations are possible, such as four or more vias surrounding a signal pin. In some embodiments, the four or more vias can be positioned circumferentially about a signal pin. In one such circumferential configuration, four vias are positioned circumferentially about the pin at approximately 90-degree intervals. The vias 1342 can have a smaller diameter than the diameter of the signal pins 1334 and 1338. In some embodiments, the shielding vias have a diameter of about 0.5 millimeters or less. The vias can comprise copper or another suitable metal, metal alloy, or other electrically conductive material. Examples of single-ended signals include data lines for DDR3 and DDR4 (double data rate) memory interfaces.

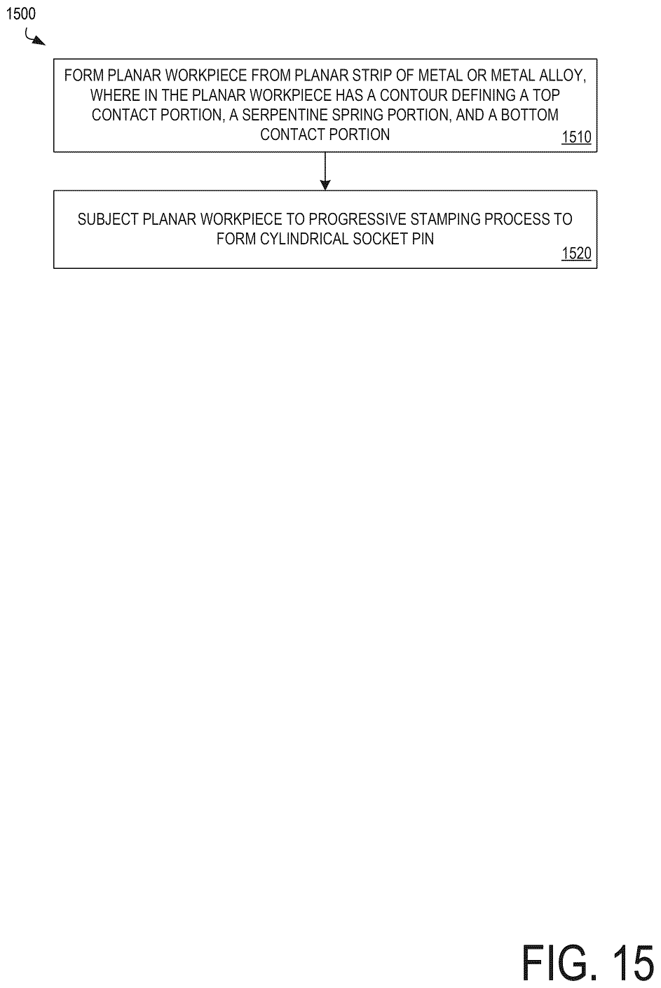

FIG. 15 is an example method of forming a socket pin. In stage 1510 in method 1500, a planar workpiece is formed from a planar strip of metal or metal alloy, wherein the planar workpiece has contours defining a top contact portion, a serpentine spring portion, and a bottom contact portion, the serpentine spring portion positioned between the top contact portion and the bottom contact portion. In stage 1520, the planar workpiece is subjected to a progressive stamping process to form a socket pin, wherein the socket pin has a cylindrical shape.

The socket structures described herein can be attached to a printed circuit board. In some embodiments, one or more additional integrated circuit components or other components, such as a battery or antenna, can be attached to the printed circuit board. In some embodiments, the printed circuit board and the integrated circuit component can be located in a computing device that comprises a housing that encloses the printed circuit board.

The technologies described herein can be implemented in any of a variety of computing systems, including non-mobile computing systems (e.g., desktop computers, servers, workstations, stationary gaming consoles, rack-level computing solutions (e.g., blade, tray, or sled computing systems)) and embedded computing systems (e.g., computing systems that are part of a vehicle, smart home appliance, consumer electronics product or equipment, manufacturing equipment).

As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that hosts companies' applications and data), or an edge data center (e.g., a data center typically having a smaller footprint than other data center types, located close to the geographic area that it serves).

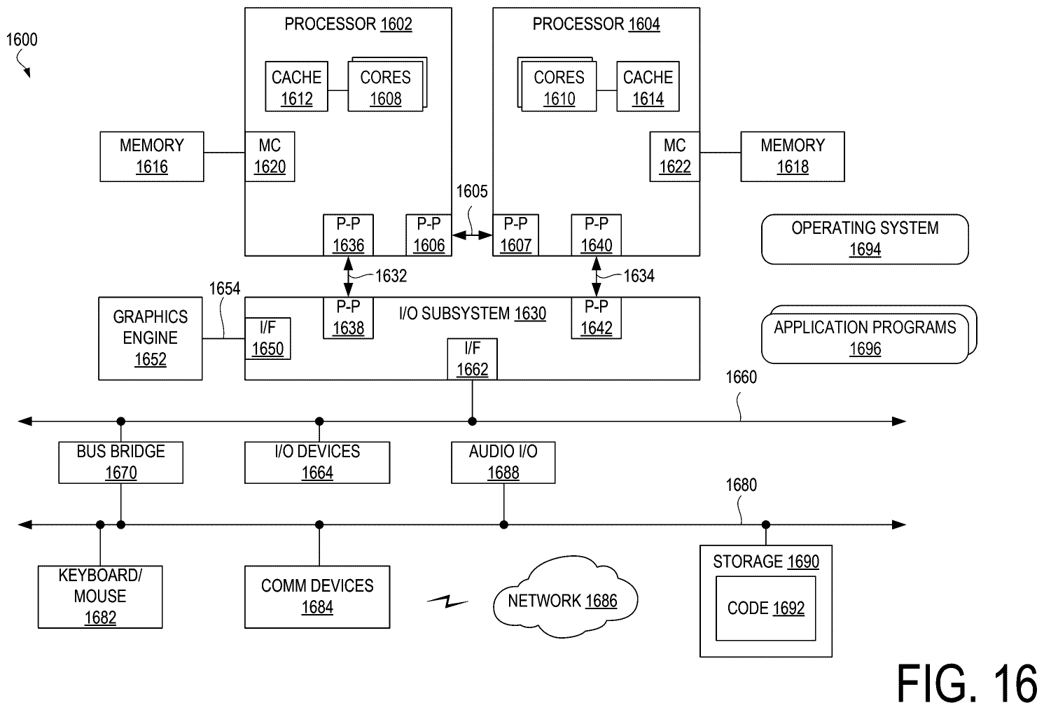

FIG. 16 is a block diagram of a second example computing system in which technologies described herein may be implemented. Generally, components shown in FIG. 16 can communicate with other components shown, although not all connections are shown, for ease of illustration. The computing system 1600 is a multiprocessor system comprising first processor unit 1602 and second processor unit 1604 comprising point-to-point (P-P) interconnects. A point-to-point (P-P) interface 1606 of the first processor unit 1602 is coupled to a point-to-point interface 1607 of the second processor unit 1604 via a point-to-point interconnection 1605. It is to be understood that any or all of the point-to-point interconnects illustrated in FIG. 16 can be alternatively implemented as a multi-drop bus, and that any or all buses illustrated in FIG. 16 could be replaced by point-to-point interconnects.

The first processor unit 1602 and second processor unit 1604 comprise multiple processor cores. The first processor unit 1602 comprises processor cores 1608 and the second processor unit 1604 comprises processor cores 1610.

The first processor unit 1602 and the second processor unit 1604 further comprise cache memories 1612 and 1614, respectively. The cache memories 1612 and 1614 can store data (e.g., instructions) utilized by one or more components of the first processor unit 1602 and the second processor unit 1604, such as the processor cores 1608 and 1610. The cache memories 1612 and 1614 can be part of a memory hierarchy for the computing system 1600.

Although the computing system 1600 is shown with two processor units, the computing system 1600 can comprise any number of processor units. Further, a processor unit can comprise any number of processor cores. A processor unit can take various forms such as a central processing unit (CPU), graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other type of processing unit. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 1600 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The first processor unit 1602 and the second processor unit 1604 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from any integrated circuit die containing a processor unit. In some embodiments, these separate integrated circuit dies can be referred to as “chiplets”. In some embodiments, where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by a package substrate, one or more silicon interposers, one or more silicon bridges embedded in a package substrate (such as Intel® embedded multi-die interconnect bridges (EMIBs)), or combinations thereof.

The first processor unit 1602 further comprises first memory controller logic (first MC 1620) and the second processor unit 1604 further comprises second memory controller logic (second MC 1622). As shown in FIG. 16, a first memory 1616 coupled to the first processor unit 1602 is controlled by the first MC 1620 and a second memory 1618 coupled to the second processor unit 1604 is controlled by the second MC 1622. The first memory 1616 and the second memory 1618 can comprise various types of volatile memory (e.g., dynamic random-access memory (DRAM), static random-access memory (SRAM)) and/or non-volatile memory (e.g., flash memory, chalcogenide-based phase-change non-volatile memories). The first memory 1616 and the second memory 1618 can comprise one or more layers of a memory hierarchy of the computing system. While first MC 1620 and second MC 1622 are illustrated as being integrated into the first processor unit 1602 and the second processor unit 1604, in alternative embodiments, memory controller logic can be external to a processor unit.

The first processor unit 1602 and the second processor unit 1604 are coupled to an Input/Output subsystem 1630 (I/O subsystem) via point-to-point interconnections 1632 and 1634. The point-to-point interconnection 1632 connects a point-to-point interface 1636 of the first processor unit 1602 with a point-to-point interface 1638 of the Input/Output subsystem 1630, and the point-to-point interconnection 1634 connects a point-to-point interface 1640 of the second processor unit 1604 with a point-to-point interface 1642 of the Input/Output subsystem 1630. Input/Output subsystem 1630 further includes an interface 1650 to couple the Input/Output subsystem 1630 to a graphics engine 1652. The Input/Output subsystem 1630 and the graphics engine 1652 are coupled via a bus 1654.

The Input/Output subsystem 1630 is further coupled to a first bus 1660 via an interface 1662. The first bus 1660 can be a Peripheral Component Interconnect Express (PCIe) bus or any other type of bus. Various I/O devices 1664 can be coupled to the first bus 1660. A bus bridge 1670 can couple the first bus 1660 to a second bus 1680. In some embodiments, the second bus 1680 can be a low pin count (LPC) bus. Various devices can be coupled to the second bus 1680 including, for example, a keyboard/mouse 1682, audio I/O devices 1688, and a storage device 1690, such as a hard disk drive, solid-state drive, or another storage device for storing computer-executable instructions (or code 1692) or data. The code 1692 can comprise computer-executable instructions for performing methods described herein. Additional components that can be coupled to the second bus 1680 include one or more communication devices 1684, which can provide for communication between the computing system 1600 and one or more wired or wireless networks 1686 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 502.11 standard and its supplements).

In embodiments where the one or more communication devices 1684 support wireless communication, the one or more communication devices 1684 can comprise wireless communication components coupled to one or more antennas to support communication between the computing system 1600 and external devices. The wireless communication components can support various wireless communication protocols and technologies.

The computing system 1600 can comprise removable memory such as flash memory cards (e.g., SD (Secure Digital) cards), memory sticks, Subscriber Identity Module (SIM) cards). The memory in computing system 1600 (including cache memories 1612 and 1614, first memory 1616, second memory 1618, and storage device 1690) can store data and/or computer-executable instructions for executing an operating system 1694 and application programs 1696. The computing system 1600 can also have access to external memory or storage (not shown) such as external hard drives or cloud-based storage.

The computing system 1600 can support various additional input devices, such as a touchscreen, microphone, or camera, and one or more output devices, such as one or more speakers or displays. External input and output devices can communicate with the computing system 1600 via wired or wireless connections. The computing system 1600 can further include at least one input/output port comprising physical connectors (e.g., USB), and/or a power supply (e.g., battery).

It is to be understood that FIG. 16 illustrates only one example computing system architecture. Computing systems based on alternative architectures can be used to implement technologies described herein. For example, instead of the first processor unit 1602, the second processor unit 1604, and the graphics engine 1652 being located on discrete integrated circuit dies, a computing system can comprise an SoC (system-on-a-chip) integrated circuit die on which multiple processors, a graphics engine, and additional components are incorporated. Further, a computing system can connect its constituent component via bus or point-to-point configurations different from that shown in FIG. 16. Moreover, the illustrated components in FIG. 16 are not required or all-inclusive, as shown components can be removed and other components added in alternative embodiments.

As used herein, the term “connected” may indicate elements are in direct physical or electrical contact with each other and the term “coupled” may indicate elements cooperate or interact with each other, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, reference to ledges in a pin opening that are substantially parallel to a surface of a socket housing includes ledges that are within several degrees of being parallel to the surface of the socket housing. Values modified by the word “about” include values within +/−10% of the listed values and values listed as being within a range include those within a range from 10% less than the listed lower range limit and 10% greater than the listed higher range limit.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components. As used herein, the term “adjacent” refers to layers or components that are arranged next to each other (e.g., side-by-side, top and bottom).

Certain terminology may also be used herein for the purpose of reference only, and thus are not intended to be limiting. For example, terms such as “upper,” “lower,” “above,” “below,” “bottom,” and “top” refer to directions in the Figures to which reference is made. Terms such as “front,” “back,” “rear,” and “side” describe the orientation and/or location of layers, components, portions of components, etc., within a consistent but arbitrary frame of reference, which is made clear by reference to the text and the associated Figures describing the layers, component, portions of components, etc. under discussion. Such terminology may include the words specifically mentioned above, derivatives thereof, and words of similar import.

As used herein, the term “integrated circuit component” refers to a packaged or unpacked integrated circuit product. A packaged integrated circuit component comprises one or more integrated circuit dies mounted on a package substrate with the integrated circuit dies and package substrate encapsulated in a casing material, such as a metal, plastic, glass, or ceramic. In one example, a packaged integrated circuit component contains one or more processor units mounted on a substrate with an exterior surface of the substrate comprising a solder ball grid array (BGA). In one example of an unpackaged integrated circuit component, a single monolithic integrated circuit die comprises solder bumps attached to contacts on the die. The solder bumps allow the die to be directly attached to a printed circuit board. An integrated circuit component can comprise one or more of any computing system component described or referenced herein or any other computing system component, such as a processor unit (e.g., system-on-a-chip (SoC), processor core, graphics processor unit (GPU), accelerator, chipset processor), I/O controller, memory, or network interface controller.

As used in this application and the claims, a list of items joined by the term “and/or” can mean any combination of the listed items. For example, the phrase “A, B, and/or C” can mean A; B; C; A and B; A and C; B and C; or A, B and C. As used in this application and the claims, a list of items joined by the term “at least one of” can mean any combination of the listed terms. For example, the phrase “at least one of A, B, or C” can mean A; B; C; A and B; A and C; B and C; or A, B, and C. Further, as used in this application and the claims, a list of items joined by the term “one or more of” can mean any combination of the listed terms. For example, the phrase “one or more of A, B, and C” can mean A; B; C; A and B; A and C; B and C; or A, B, and C. Moreover, as used in this application and the claims, a list of items joined by the term “one of” can mean any one of the listed terms. For example, the phrase “one of A, B, or C” can mean A, B, or C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 comprises an apparatus comprising: a pin comprising: a top contact portion; a bottom contact portion; and a serpentine spring portion positioned between and attached to the top contact portion and the bottom contact portion; and a housing comprising: a first board comprising a first opening; and a second board attached to the first board, wherein the second board comprises a second opening aligned with the first opening, the first opening and the second opening define a pin opening, and the pin is located within the pin opening.

Example 2 comprises the apparatus of example 1, further comprising a strip extending from the top contact portion to the bottom contact portion.

Example 3 comprises the apparatus of example 2, wherein the strip comprises a bend and the bend extends towards an interior of the serpentine spring portion.

Example 4 comprises the apparatus of example 2, wherein the strip comprises a bend and the bend extends towards a vertical centerline of the serpentine spring portion.

Example 5 comprises the apparatus of example 1, further comprising a stub extending outward from the pin.

Example 6 comprises the apparatus of example 5, further comprising a stub extending outward from the serpentine spring portion.

Example 7 comprises the apparatus of example 5 or 6, wherein the stub is elongated.

Example 8 comprises the apparatus of any one of examples 1-7, wherein the serpentine spring portion comprises at least five turns.

Example 9 comprises the apparatus of any one of examples 1-8, wherein a height of the pin is in a range of about 1.8 millimeters to about 2.3 millimeters.

Example 10 comprises the apparatus of any one of examples 1-9, wherein a height of the pin is less than about 2.0 millimeters.

Example 11 comprises the apparatus of any one of examples 1-10, wherein a diameter of the serpentine spring portion is in a range of about 0.6 millimeters to about 0.8 millimeters.

Example 12 comprises the apparatus of any one of examples 1-11, wherein a diameter of the serpentine spring portion is less than about 0.6 millimeters.

Example 13 comprises the apparatus of any one of examples 1-12, wherein the top contact portion, the serpentine spring portion and the bottom contact portion comprise beryllium and copper.

Example 14 comprises the apparatus of any one of examples 1-13, wherein the pin comprises a coating comprising palladium and gold.

Example 15 comprises the apparatus of any one of examples 1-13, wherein the pin comprises a coating comprising nickel.

Example 16 comprises the apparatus of any one of examples 1-13, wherein the pin comprises a coating comprising copper and zinc.

Example 17 comprises the apparatus of any one of examples 1-16, wherein a height of the housing is about 1.85 millimeters or less.

Example 18 comprises the apparatus of any one of examples 1-17, wherein the pin opening is plated with a metal or metal alloy.

Example 19 comprises the apparatus of any one of examples 1-18, further comprising a plurality of vias extending through the housing, wherein the plurality of vias surround the pin opening.

Example 20 comprises the apparatus of example 19, wherein the plurality of vias comprise four vias positioned circumferentially about the pin at approximately 90-degree intervals.

Example 21 comprises the apparatus of example 19, wherein the plurality of vias comprises eight vias, wherein the eight vias and the pin are arranged substantially in a grid-like arrangement defining three rows and three columns, the pin being positioned at an intersection of a middle row of the three rows and a middle column of the three columns.

Example 22 comprises the apparatus of any one of examples 19-21, wherein individual of the plurality of vias have a diameter of less than about 0.5 millimeters.

Example 23 comprises the apparatus of any one of examples 19-22, further comprising a plurality of additional pins, wherein individual of the plurality of additional pins comprise a top contact portion, a bottom contact portion, and a serpentine spring portion positioned between the top contact portion and the bottom contact portion; and wherein the plurality of vias are positioned between the pin and the plurality of additional pins.

Example 24 comprises an assembly comprising: a socket housing comprising a pin opening extending from a first surface of the socket housing to a second surface of the socket housing that is opposite to the first surface; a pin located in the pin opening, the pin comprising: a top contact portion; a bottom contact portion; and a serpentine spring portion positioned between the top contact portion and the bottom contact portion; and a printed circuit board, wherein the bottom contact portion of the pin is attached to a surface of the printed circuit board.

Example 25 comprises the assembly of example 24, wherein the bottom contact portion of the pin is attached to the printed circuit board via a solder connection.

Example 26 comprises the assembly of example 24, wherein a top surface of the top contact portion extends past a top surface of the socket housing.

Example 27 comprises the assembly of any one of examples 24-26, further comprising a strip extending from the top contact portion to the bottom contact portion.

Example 28 comprises the assembly of example 27, wherein the strip comprises a bend and the bend extends towards a vertical centerline of the serpentine spring portion.

Example 29 comprises the assembly of example 24, further comprising a stub extending outward from the pin, wherein the pin opening is partially plated with a layer of metal, the stub is to be in direct physical contact with the layer of metal when the pin is in a compressed state defined by an integrated circuit component being attached to the socket housing, and the stub is to be not in direct physical contact with the layer of metal when the pin is in an uncompressed state.

Example 30 comprises the assembly of example 29, wherein the stub extends outward from the serpentine spring portion.

Example 31 comprises the assembly of example 29 or 30, wherein the stub is elongated.

Example 32 comprises the assembly of any one of examples 29-31, wherein the pin opening comprises a recess that accommodates the stub when the pin is in the compressed state or the uncompressed state.

Example 33 comprises the assembly of any one of examples 29-32, wherein the stub is to bend when the pin is placed in the compressed state.

Example 34 comprises the assembly of any one of examples 29-33, wherein the bottom contact portion of the pin is attached to the surface of the printed circuit board via a solder connection and a portion of the solder connection is between a surface of the layer of metal at a bottom surface of the socket housing and the surface of the printed circuit board.

Example 35 comprises the assembly of any one of examples 24-34, wherein the top contact portion, the serpentine spring portion and the bottom contact portion comprise beryllium and copper.

Example 36 comprises the assembly of any one of examples 24-35, wherein the pin comprises a coating comprising palladium and gold.

Example 37 comprises the assembly of any one of examples 24-36, wherein a height of the socket housing is about 1.85 millimeters or less.

Example 38 comprises the assembly of any one of examples 24-37, wherein the pin opening comprises one or more surfaces, the assembly further comprising a layer of metal positioned between the pin and the one or more surfaces.

Example 39 comprises the assembly of any one of examples 24-38, further comprising a plurality of vias extending through the socket housing, wherein the plurality of vias surround the pin opening.

Example 40 comprises the assembly of example 39, wherein the plurality of vias comprises four vias positioned circumferentially about the pin at approximately 90-degree intervals.

Example 41 comprises the assembly of example 39, wherein the plurality of vias comprises eight vias, wherein the eight vias and the pin are arranged substantially in a grid-like arrangement defining three rows and three columns, the pin being positioned at an intersection of a middle row of the three rows and a middle column of the three columns.

Example 42 comprises an assembly comprising: a socket housing comprising a pin opening; a pin located in the pin opening, the pin comprising: a top contact portion; a bottom contact portion; and a serpentine spring portion positioned between the top contact portion and the bottom contact portion; and an integrated circuit component comprising a land, wherein the land is electrically conductive, the land is in physical contact with the top contact portion of the pin, and the serpentine spring portion is compressed.

Example 43 comprises the assembly of example 42, further comprising a plurality of additional pins that are nearest neighbor pins to the pin, wherein individual of the plurality of additional pins comprise a top contact portion, a bottom contact portion, a serpentine spring positioned between the top contact portion and the bottom contact portion; and wherein the top contact portions of the plurality of additional pins are in physical contact with power supply lands and/or ground lands of the integrated circuit component.

Example 44 comprises the assembly of any one of examples 42, wherein the pin is a first pin, the assembly further comprising: a second pin comprising a top contact portion, a bottom contact portion, and a serpentine spring positioned between the top contact portion and the bottom contact portion, the first pin positioned adjacent to the second pin, the first pin and the second pin forming a differential pair; and a plurality of additional pins that are nearest neighbors to the differential pair, wherein individual of the plurality of additional pins comprise a top contact portion, a bottom contact portion comprises a serpentine spring positioned between the top contact portion and the bottom contact portion; and wherein the top contact portions of the plurality of additional pins are in physical contact with power supply lands and/or ground lands of the integrated circuit component.

Example 45 comprises the assembly of example 44 wherein the plurality of additional pins consists of six pins.

Example 46 comprises the assembly of example 44, wherein the plurality of additional pins consists of eight pins.

Example 47 comprises the assembly of any one of examples 42-46, further comprising a printed circuit board, wherein the bottom contact portion of the pin is attached to a surface of the printed circuit board.

Example 48 comprises the assembly of any one of examples 42-47, further comprising a strip extending from the top contact portion to the bottom contact portion.

Example 49 comprises the assembly of example 48, wherein the strip comprises a bend and the bend extends towards an interior of the serpentine spring portion.

Example 50 comprises the assembly of example 42, further comprising a stub extending outward from the pin; wherein the pin opening is partially plated with a layer of metal, the stub in direct physical contact with the layer of metal when the pin is a compressed state due to an integrated circuit component being attached to the socket housing.

Example 51 comprises the assembly of example 50, wherein the stub extends outward from the serpentine spring portion.

Example 52 comprises the assembly of example 50 or 51, wherein the stub is elongated.

Example 53 comprises the assembly of any one of examples 50-52, wherein the pin opening comprises a recess that accommodates the stub.

Example 54 comprises the assembly of any one of examples 50-53, wherein the stub is to bend when the pin is placed in the compressed state.

Example 55 comprises the assembly of any one of examples 50-54, further comprises a printed circuit board, wherein the bottom contact portion of the pin is attached to a surface of the printed circuit board via a solder connection and a portion of the solder connection is positioned between a surface of the layer of metal at a bottom surface of the socket housing and the surface of the printed circuit board.

Example 56 comprises the assembly of any one of examples 42-49, wherein the pin opening comprises one or more surfaces, the assembly further comprising a layer of metal positioned between the pin and the one or more surfaces.

Example 57 comprises the assembly of any one of examples 42-56, further comprising a plurality of vias extending through the socket housing, wherein the plurality of vias surrounds the pin opening.

Example 58 comprises the assembly of example 57, wherein the plurality of vias comprises eight vias, wherein the eight vias and the pin are arranged substantially in a grid-like arrangement defining three rows and three columns, the pin being positioned at an intersection of a middle row of the three rows and a middle column of the three columns.

Example 59 comprises a method comprising: forming a planar workpiece from a planar strip of metal or metal alloy, where in the planar workpiece has a contour defining a top contact portion, a serpentine spring portion, and a bottom contact portion, the serpentine spring portion positioned between the top contact portion and the bottom contact portion; and subjecting the planar workpiece to a progressive stamping process to form a socket pin, wherein the socket pin has a cylindrical shape.

Example 60 comprises the method of example 59, wherein the contour of the planar workpiece further defines a strip comprising a bend, the strip extends from the top contact portion to the bottom contact portion.

1. An apparatus comprising:
a pin comprising:
a top contact portion;
a bottom contact portion; and
a serpentine spring portion positioned between and attached to the top contact portion and the bottom contact portion; and
a housing comprising:
a first board comprising a first opening; and
a second board attached to the first board, wherein the second board comprises a second opening aligned with the first opening, the first opening and the second opening define a pin opening, and the pin is located within the pin opening.

2. The apparatus of claim 1, further comprising a strip extending from the top contact portion to the bottom contact portion.

3. The apparatus of claim 2, wherein the strip comprises a bend and the bend extends towards an interior of the serpentine spring portion.

4. The apparatus of claim 1, wherein a height of the housing is about 1.85 millimeters or less.

5. The apparatus of claim 1, wherein the pin opening is plated with a metal or metal alloy.

6. The apparatus of claim 1, further comprising a plurality of vias extending through the housing, wherein the plurality of vias surround the pin opening.

7. An assembly comprising:
a socket housing comprising a pin opening extending from a first surface of the socket housing to a second surface of the socket housing that is opposite to the first surface;
a pin located in the pin opening, the pin comprising:
a top contact portion;
a bottom contact portion; and
a serpentine spring portion positioned between the top contact portion and the bottom contact portion; and
a printed circuit board, wherein the bottom contact portion of the pin is attached to a surface of the printed circuit board.

8. The assembly of claim 7, further comprising a strip extending from the top contact portion to the bottom contact portion, wherein the strip comprises a bend and the bend extends towards a vertical centerline of the serpentine spring portion.

9. The assembly of claim 7, further comprising a stub extending outward from the pin, wherein the pin opening is partially plated with a layer of metal, the stub is to be in direct physical contact with the layer of metal when the pin is in a compressed state defined by an integrated circuit component being attached to the socket housing, and the stub is to be not in direct physical contact with the layer of metal when the pin is in an uncompressed state.

10. The assembly of claim 9, wherein the stub extends outward from the serpentine spring portion.

11. The assembly of claim 9, wherein the pin opening comprises a recess that accommodates the stub when the pin is in the compressed state or the uncompressed state.

12. The assembly of claim 9, wherein the stub is to bend when the pin is placed in the compressed state.

13. The assembly of claim 9, wherein the bottom contact portion of the pin is attached to the surface of the printed circuit board via a solder connection and a portion of the solder connection is between a surface of the layer of metal at a bottom surface of the socket housing and the surface of the printed circuit board.

14. The assembly of claim 9, further comprising a plurality of vias extending through the socket housing, wherein the plurality of vias surrounds the pin opening.

15. An assembly comprising:
a socket housing comprising a pin opening;
a pin located in the pin opening, the pin comprising:
a top contact portion;
a bottom contact portion; and
a serpentine spring portion positioned between the top contact portion and the bottom contact portion; and
an integrated circuit component comprising a land, wherein the land is electrically conductive, the land is in physical contact with the top contact portion of the pin, and the serpentine spring portion is compressed.

16. The assembly of claim 15, further comprising a plurality of additional pins that are nearest neighbor pins to the pin, wherein individual of the plurality of additional pins comprise a top contact portion, a bottom contact portion, a serpentine spring positioned between the top contact portion and the bottom contact portion; and wherein the top contact portions of the plurality of additional pins are in physical contact with power supply lands and/or ground lands of the integrated circuit component.

17. The assembly of claim 15, wherein the pin is a first pin, the assembly further comprising:
a second pin comprising a top contact portion, a bottom contact portion, and a serpentine spring positioned between the top contact portion and the bottom contact portion, the first pin positioned adjacent to the second pin, the first pin and the second pin forming a differential pair; and
a plurality of additional pins that are nearest neighbors to the differential pair, wherein individual of the plurality of additional pins comprise a top contact portion, a bottom contact portion. a serpentine spring positioned between the top contact portion and the bottom contact portion; and wherein the top contact portions of the plurality of additional pins are in physical contact with power supply lands and/or ground lands of the integrated circuit component.

18. The assembly of claim 15, further comprising a printed circuit board, wherein the bottom contact portion of the pin is attached to a surface of the printed circuit board.

19. The assembly of claim 15, further comprising a strip extending from the top contact portion to the bottom contact portion.

20. The assembly of claim 15, further comprising a stub extending outward from the pin; wherein the pin opening is partially plated with a layer of metal, the stub is in direct physical contact with the layer of metal when the pin is a compressed state due to an integrated circuit component being attached to the socket housing, the pin opening comprising a recess that accommodates the stub, the pin opening comprises one or more surfaces, and the assembly further comprises a layer of metal positioned between the pin and the one or more surfaces.
